(19) United States
(12) Patent Application Publication
(10) Pub. No.: US 2015/0170851 A1
(43) Pub. Date: Jun. 18, 2015

(54) ELECTRONIC APPARATUS AND CIRCUIT MODULE

(71) Applicant: Kabushiki Kaisha Toshiba, Tokyo (JP)

(72) Inventors: Kiyomi Muro, Hachioji-shi (JP); Hideki Ogawa, Hino-shi (JP)

(21) Appl. No.: 14/459,109

(22) Filed: Aug. 13, 2014

Related U.S. Application Data
(60) Provisional application No. 61/917,161, filed on Dec. 17, 2013.

(51) Int. Cl. H01H 13/04; H01H 13/14

(52) U.S. Cl. CPC H01H 13/04; H01H 13/14; H01H 2231/002; H01H 2221/09

(57) ABSTRACT

According to one embodiment, an electronic apparatus includes a circuit module. The circuit module includes a flexible substrate. The flexible substrate includes a base portion having a mounting surface, and an extension portion. On the mounting surface, conductor patterns are provided. A switch is provided in a fore-end portion of the extension portion and includes an operating portion operated by a pushing portion of a housing. A first pressure receiving portion is located behind the switch. A second pressure receiving portion is provided on the mounting surface. The extension portion is folded back once toward the mounting surface.

### CROSS-REFERENCE TO RELATED APPLICATIONS

This application claims the benefit of U.S. Provisional Application No. 61/917,161, filed Dec. 17, 2013, the entire contents of which are incorporated herein by reference.

### FIELD

Embodiments described herein relate generally to an electronic apparatus and a circuit module.

### BACKGROUND

In an electronic apparatus with a detachable display for example, a pushbutton is provided on the surface of the display housing. When an operator pushes the pushbutton with his/her fingertip, a switch contained in the display housing is turned on or off.

Here, it is desirable that the switch be mounted on the mounting surface of a flexible substrate located directly underneath the pushbutton. However, if a plurality of conductor patterns are formed by wiring on the mounting surface corresponding to a portion directly underneath the pushbutton, it is difficult to mount the switch on the conductor patterns.

Conventionally, therefore, a band-shaped extension portion is formed along the periphery of the flexible substrate and drawn around the flexible substrate, and the switch is mounted in a fore-end portion of the extension portion. After the extension portion is folded several times such that the switch is positioned directly underneath the pushbutton, the extension portion is bonded to the mounting surface.

However, with conventional flexible substrates, a cumulative dimensional error is likely to occur each time the extension portion is folded. As a result, it is difficult to position the switch and the pushbutton with high accuracy. Consequently, the responsiveness of the switch is reduced.

Further, since the extension portion must be folded several times, its overall length inevitably becomes great and its shape becomes clearly complicated. Consequently, the manufacturing yield of the flexible substrate decreases, which becomes a factor in increasing the cost of the electronic apparatus.

### BRIEF DESCRIPTION OF THE DRAWINGS

A general architecture that implements the various features of the embodiments will now be described with reference to the drawings. The drawings and the associated descriptions are provided to illustrate the embodiments and not to limit the scope of the invention.

FIG. 1 is an exemplary perspective view of a portable computer according to a first embodiment;

FIG. 2 is an exemplary perspective view of the portable computer in which a display is detached from a computer main body;

FIG. 3 is an exemplary plan view of the display;

FIG. 4 is an exemplary plan view of a circuit module according to the first embodiment in which an extension portion of a flexible substrate is folded out;

FIG. 5 is an exemplary sectional view, taken along a line F5-F5 in FIG. 4;

FIG. 6 is an exemplary plan view of the circuit module according to the first embodiment, showing a positional relationship between a switch and a first connector when the extension portion of the flexible substrate is folded back once;

FIG. 7 is an exemplary sectional view of the portable computer according to the first embodiment when the circuit module is cut along a line F7-F7 in FIG. 6, to show a positional relationship between the switch and a pushbutton;

FIG. 8 is an exemplary sectional view of the portable computer according to the first embodiment, showing a positional relationship between the switch and the pushbutton when the pushbutton is pressed;

FIG. 9 is an exemplary plan view of a circuit module according to a second embodiment in which an extension portion of a flexible substrate is folded out;

FIG. 10 is an exemplary plan view of the circuit module according to the second embodiment, showing a positional relationship between a switch and a first connector when the extension portion of the flexible substrate is folded back once;

FIG. 11 is an exemplary sectional view, taken along a line F11-F11 of the circuit module in FIG. 10, to show a positional relationship between the switch and a pushbutton;

FIG. 12 is an exemplary section view of a portable computer according to a third embodiment, showing a positional relationship between a switch and a pushbutton;

FIG. 13 is an exemplary sectional view showing a state where the switch is inclined with respect to a second reinforcing plate by the action of pushing the pushbutton; and

FIG. 14 is an exemplary sectional view showing a state where the inclination of the switch is inhibited.

### DETAILED DESCRIPTION

Various embodiments will be described hereinafter with reference to the accompanying drawings.

In general, according to one embodiment, an electronic apparatus comprises a circuit module inside a housing. The circuit module comprises a flexible substrate, a switch, a first pressure receiving portion and a second pressure receiving portion. The flexible substrate includes a base portion comprising a mounting surface, and an extension portion extended from the base portion. On the mounting surface, a plurality of conductor patterns is provided. The switch is provided in a fore-end portion of the extension portion and comprises an operating portion operated by a pushing portion of the housing. The first pressure receiving portion is located behind the switch. The second pressure receiving portion is provided on the mounting surface. The extension portion is folded back once toward the mounting surface. By doing this, the switch is interposed between the first pressure receiving portion and the second pressure receiving portion, the operating portion of the switch faces the second pressure receiving portion, and the first pressure receiving portion faces to the direction of the pushing portion.

### First Embodiment

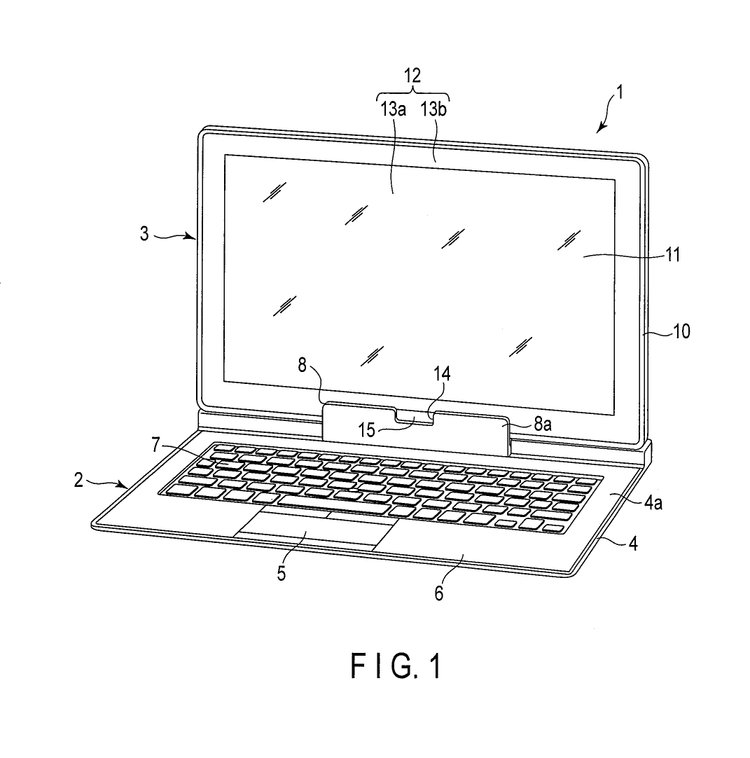

Hereinafter, a first embodiment will be described with reference to FIGS. 1 to 8.

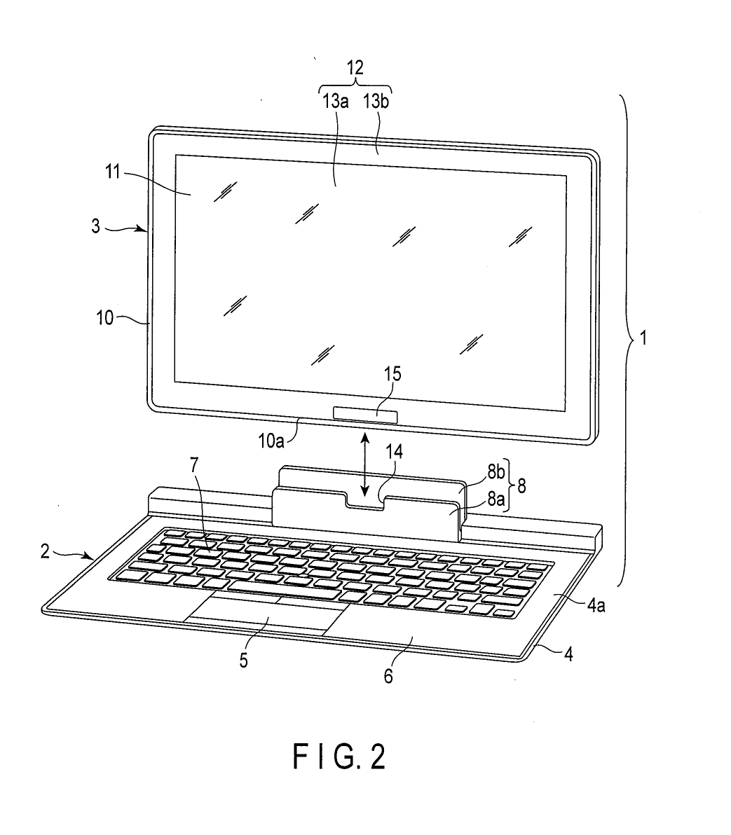

FIGS. 1 and 2 illustrate an example of an electronic apparatus, namely, a portable computer 1. The portable computer 1 comprises a computer main body 2 and a display 3. The computer main body 2 comprises a flat first housing 4. A palm rest 6 comprising a touch pad 5, and a keyboard 7 are provided on a top surface 4a of the first housing 4. The keyboard 7 is provided behind the palm rest 6.

A display supporting portion 8 is rotatably supported in a rear-end portion of the top surface 4a of the first housing 4. The display supporting portion 8 is located behind the keyboard 7 in a central portion along the width of the first housing 4. The display supporting portion 8 comprises a front plate 8a and a back plate 8b. The front plate 8a and back plate 8b extend along the width of the first housing 4 and face each other along the depth of the first housing 4 with a gap therebetween.

The display 3 comprises a second housing 10 and a display module 11 with a handwriting input function. The second housing 10 has the shape of a flat, rectangular box of a size substantially the same as that of the first housing 4. The display module 11 is contained in the second housing 10 and comprises a front panel 12 which is exposed from the surface of the second housing 10. The front panel 12 includes a rectangular display region 13a configured to display an image, video and the like, and a mask portion 13b which surrounds the display region 13a.

As shown in FIG. 2, the display 3 is detachably supported by the display supporting portion 8 of the computer main body 2. More specifically, one end portion 10a of the second housing 10 is interposed between the front plate 8a and the back plate 8b, and held by both plates 8a and 8b. The front plate 8a is placed on one side of the mask portion 13b of the display 3. In a central portion of the front end edge of the front plate 8a, a notch 14 is formed.

In the first embodiment, in a state where the display 3 is attached to the display supporting portion 8, the display 3 can be used in a manner similar to that of an ordinary notebook-sized portable computer. In contrast, in a state where the display 3 is detached from the display supporting portion 8, the display 3 can be used alone as a tablet computer.

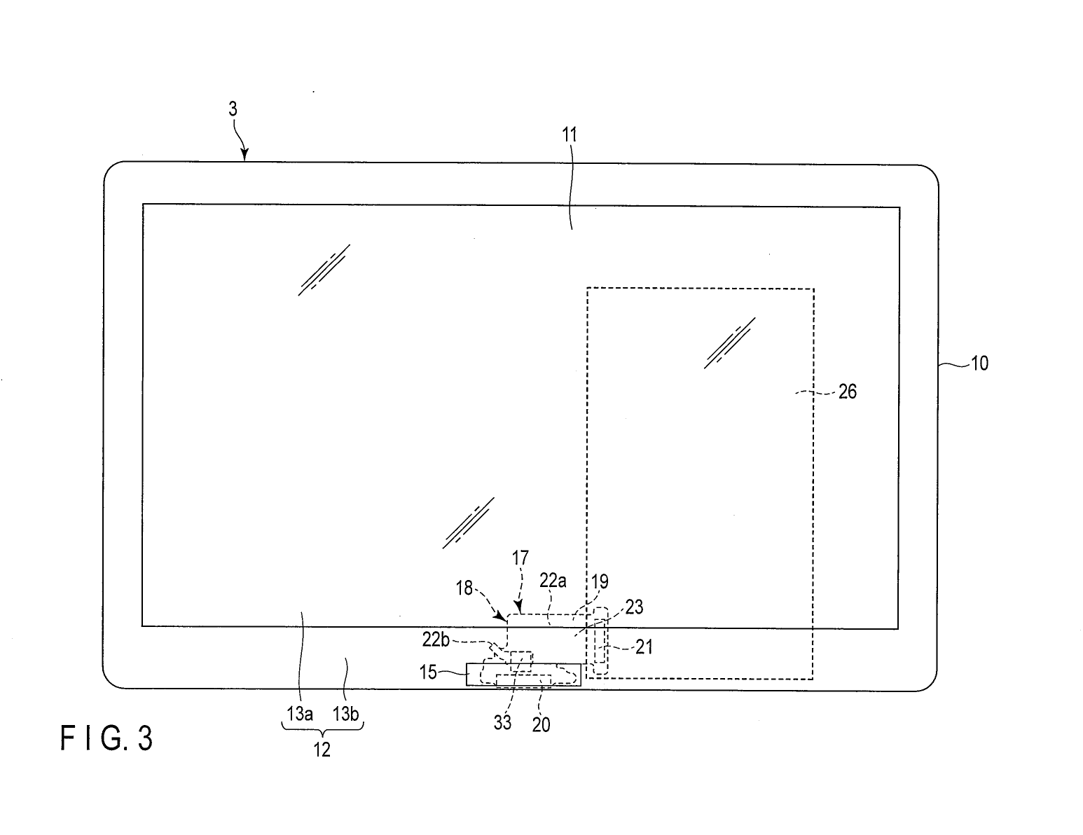

As shown in FIG. 3, a pushbutton 15 is provided on one side of the mask portion 13b of the display 3. The pushbutton 15 is an example of a pushing portion which receives pressure from outside and is located in one end portion 10a of the second housing 10. That is, the pushbutton 15 is an element pressed by an operator of the portable computer 1 with the operator's fingertip and has, for example, an elongate shape along the width of the display 3. The pushbutton 15 is exposed to the outside of the portable computer 1 through the notch 14 when the display 3 is attached to the display supporting portion 8.

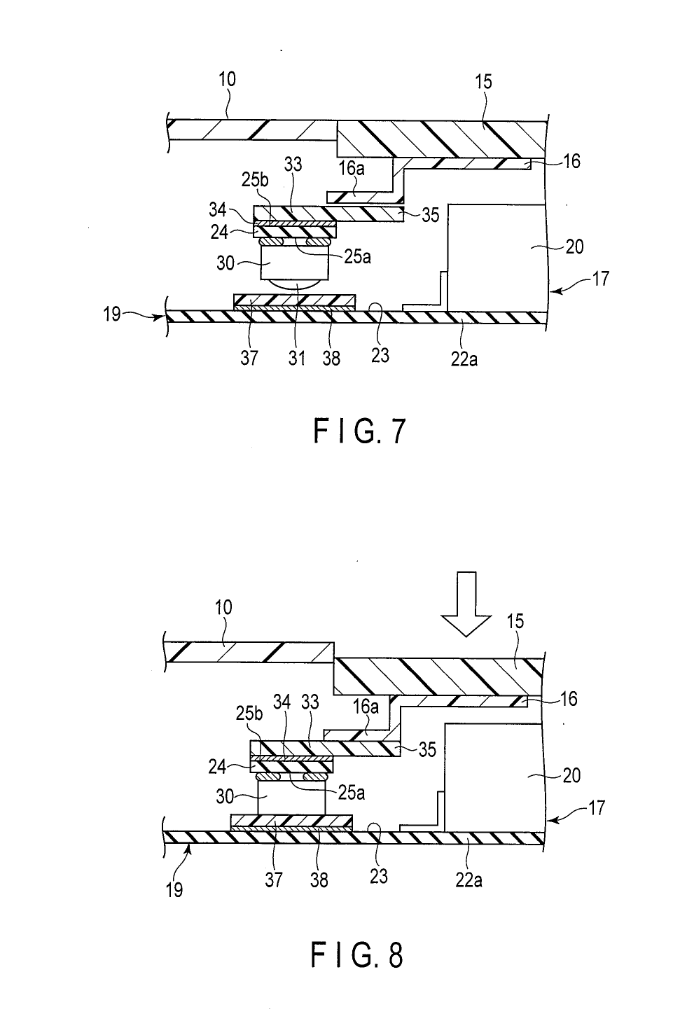

Further, as shown in FIG. 7, the pushbutton 15 comprises a switch operation element 16. The switch operation element 16 comprises an operation end portion 16a which overhangs in the second housing 10 and is biased with respect to the pushbutton 15.

As shown in FIG. 3, a circuit module 17 is contained in the second housing 10. The circuit module 17 is an element to connect the display 3 and the computer main body 2 electrically when the display 3 is attached to the display supporting portion 8.

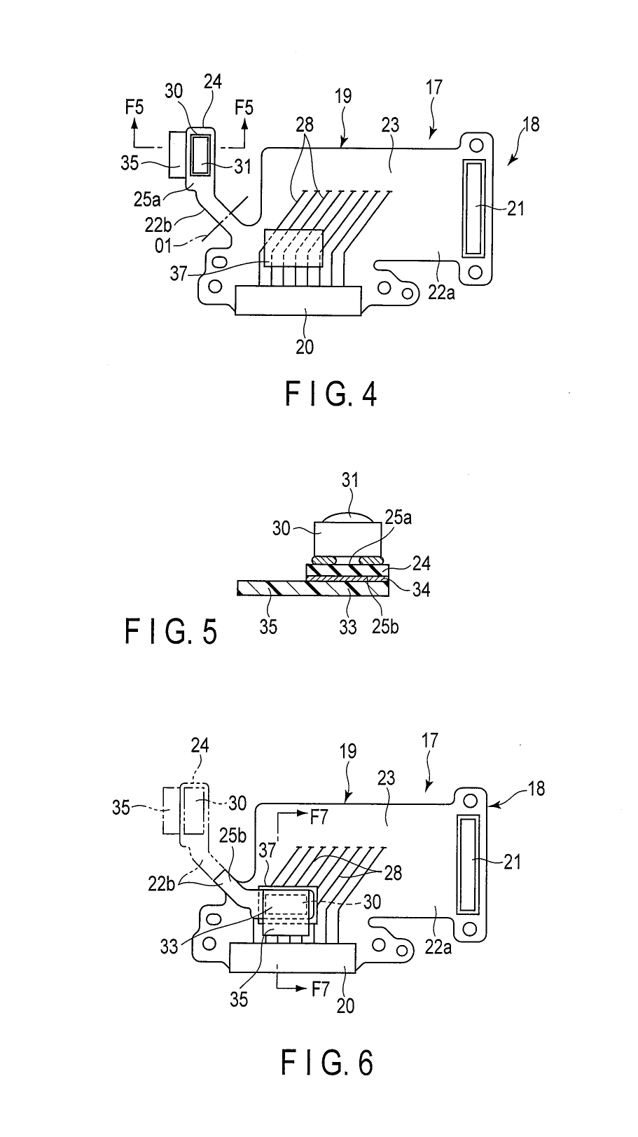

As shown in FIGS. 4 and 6, the circuit module 17 comprises a single-sided flexible printed circuit board 18. The single-sided flexible printed circuit board 18 comprises a flexible substrate 19, a first connector 20 and a second connector 21. The flexible substrate 19 comprises a base portion 22a and an extension portion 22b. The base portion 22a is substantially rectangular, one surface of which is a mounting surface 23. The flexible substrate 19 is secured to the inner surface of the second housing 10 with a plurality of screws in such a posture that the mounting surface 23 faces to the direction of the pushbutton 15.

The extension portion 22b is, for example, a band-shaped. The extension portion 22b extends laterally from the periphery of the base portion 22a as a single unit. A rectangular switch supporting portion 24 is formed in a fore-end portion of the extension portion 22b. The switch supporting portion 24 comprises a first surface 25a contiguous to the mounting surface 23, and a second surface 25b located behind the first surface 25a.

The first connector 20 and the second connector 21 are, in the first place, parts of the circuit components. The first connector 20 is secured to one end portion of the mounting surface 23 by means of solder or the like and exposed to the outside of the display 3 from one end portion 10a of the second housing 10. The first connector 20 is detachably connected to a connector receptacle (not shown) which is embedded in the display supporting portion 8, when the display 3 is attached to the display supporting portion 8.

The second connector 21 is secured to an end portion of the mounting surface 23, located away from the first connector 20 by means of solder or the like. The second connector 21 is connected to a main board 26 contained in the second housing 10.

The first connector 20 and the second connector 21 are electrically connected via a plurality of conductor patterns 28. The conductor patterns 28 are arranged on the mounting surface 23 in such a manner as to connect the first connector 20 and the second connector 21. The conductor patterns 28 are covered with a resist layer (not shown).

As shown in FIG. 5, a switch 30 is soldered onto the first surface 25a of the switch supporting portion 24. The switch 30 comprises a dome-shaped operating portion 31. The operating portion 31 is configured to project from the switch 30 and to retreat into the switch 30 producing a click sensation when it receives pressure.

A first reinforcing plate 33 is secured onto the second surface 25b of the switch supporting portion 24 via an adhesive 34. The first reinforcing plate 33 is an example of the first pressure receiving portion which receives pressure when the pushbutton 15 is pushed and is made of, for example, a resin material which is harder than the extension portion 22b of the flexible substrate 19. The first reinforcing plate 33 supports the switch 30 from behind and comprises a projecting portion 35 overhanging around the switch 30.

As shown in FIG. 6, the extension portion 22b of the flexible substrate 19 is folded back once toward the mounting surface 23 along a folding line 01 (shown in FIG. 4) which is provided between the switch supporting portion 24 and the periphery of the base portion 22a, as a guide. By this folding back, as shown in FIG. 7, the operating portion 31 of the switch 30 is directed to the mounting surface 23 in a position next to the first connector 20, and the first reinforcing plate 33 faces to the direction of the pushbutton 15. The projecting portion 35 of the first reinforcing plate 33 overhangs in the second housing 10 between the switch 30 and the first connector 20. Further, the projecting portion 35 is in proximity to or in contact with the operation end portion 16a of the switch operation element 16.

Therefore, as shown in FIGS. 7 and 8, the switch 30 is provided inside the second housing 10 at a position deviated from the pushbutton 15, and the projecting portion 35 of the first reinforcing plate 33 overhangs from the first reinforcing plate 33 in such a manner as to be positioned directly underneath the operation end portion 16a of the switch operation element 16 in the pushing direction.

As shown in FIGS. 4, 6 to 8, the second reinforcing plate 37 is secured onto the mounting surface 23 of the flexible substrate 19 via an adhesive 38. The second reinforcing plate 37 is an example of the second pressure receiving portion which receives pressure when the pushbutton 15 is pushed and is made of, for example, a resin material which is harder than the base portion 22a of the flexible substrate 19. The second reinforcing plate 37 faces the operating portion 31 of the switch 30 on the mounting surface 23. In other words, the second reinforcing plate 37 is interposed between the mounting surface 23 and the operating portion 31 of the switch 30 to receive the operating portion 31.

FIG. 7 shows a state before the pushbutton 15 is pushed. As shown in FIG. 7, the operating portion 31 of the switch 30 is slightly apart from the second reinforcing plate 37 by the elastic restoring force of the extension portion 22b folded back once. Further, the projecting portion 35 of the first reinforcing plate 33 behind the switch 30 faces the operation end portion 16a of the switch operation element 16.

As shown by an arrow of FIG. 8, when the pushbutton 15 of the display 3 is pushed with an operator's fingertip, the operation end portion 16a of the switch operation element 16 strikes the projecting portion 35 of the first reinforcing plate 33. Consequently, the extension portion 22b of the flexible substrate 19 is displaced so as to come close to the mounting surface 23 by taking the folded portion as a fulcrum and the switch 30 is pressed toward the mounting surface 23.

In other words, the switch 30 is pushed from the direction of the first reinforcing plate 33 behind, and the operating portion 31 of the switch 30 is pressed against the second reinforcing plate 37 via the first reinforcing plate 33. As a result, the operating portion 31 retreats into the switch 30 producing a click sensation, and the switch 30 is turned on or off.

In the first embodiment, by folding the extension portion 22 of the flexible substrate 19 once, the switch 30 is positioned above the mounting surface 23 of the flexible substrate 19 and pressed toward the second reinforcing plate 37 from the direction of the first reinforcing plate 33 behind the switch 30.

With this structure, the extension portion 22b to which the switch 30 is bonded need only be folded back once. Consequently, in comparison with conventional techniques, which require the extension portion to be folded several times, a dimensional error in the positional relationship between the operating portion 31 of the switch 30 and the pushbutton 15 is less likely to occur.

Therefore, the operating portion 31 of the switch 30 and the pushbutton 15 can be positioned with high accuracy. Consequently, when the pushbutton 15 is pressed, the pressure is dependably transmitted to the operating portion 31 of the switch 30, which enhances the responsiveness of the switch 30.

In addition, the first reinforcing plate 33 comprises the projecting portion 35 which overhangs around the switch 30, and the first reinforcing plate 33 is larger than the switch 30 in shape. Therefore, even if the operating portion 31 of the switch 30 is deviated from the pushbutton 15, it is possible to receive the pressure applied from the pushbutton 15 by the projecting portion 35 of the first reinforcing plate 33 and transmit to the operating portion 31 of the switch 30. Further, with the projecting portion 35 provided for the first reinforcing plate 33, it is possible to absorb, by the projecting portion 35, a common difference occurred, for example, in a portion of the switch supporting portion 27 to which the switch 30 is secured or a portion to which the pushbutton 15 is attached.

As a result, the operating portion 31 of the switch 30 can be operated dependably by the pushbutton 15, which enhances the operability of the switch 30.

In addition, even in an environment where the switch 30 cannot be provided directly underneath the pushbutton 15 in the pressing direction, it is possible to receive the pressure of the pushbutton 15 by the projecting portion 35 of the first reinforcing plate 33 and transmit the pressure to the switch 30. Therefore, the position of the pushbutton 15 need not be changed to accord with the position of the switch 30. Consequently, the first housing 4 needs no structural change and will have a structure advantageous in reducing the cost of the display 3.

Further, since the extension portion 22b of the flexible substrate 19 need only be folded once, it can be shortened and its shape simplified in comparison with the results obtained by conventional techniques. Therefore, the size of the flexible substrate 19 as a whole can be reducced, which improves the yield of forming the flexible substrate 19.

In addition, since the extension portion 22b is folded only once to position the switch 30 above the mounting surface 23, the operation processes for folding the extension portion 22b can be reduced in comparison with conventional techniques. Consequently, the costs of manufacturing the circuit module 17 and even of the display 3 can be reduced.

### Second Embodiment

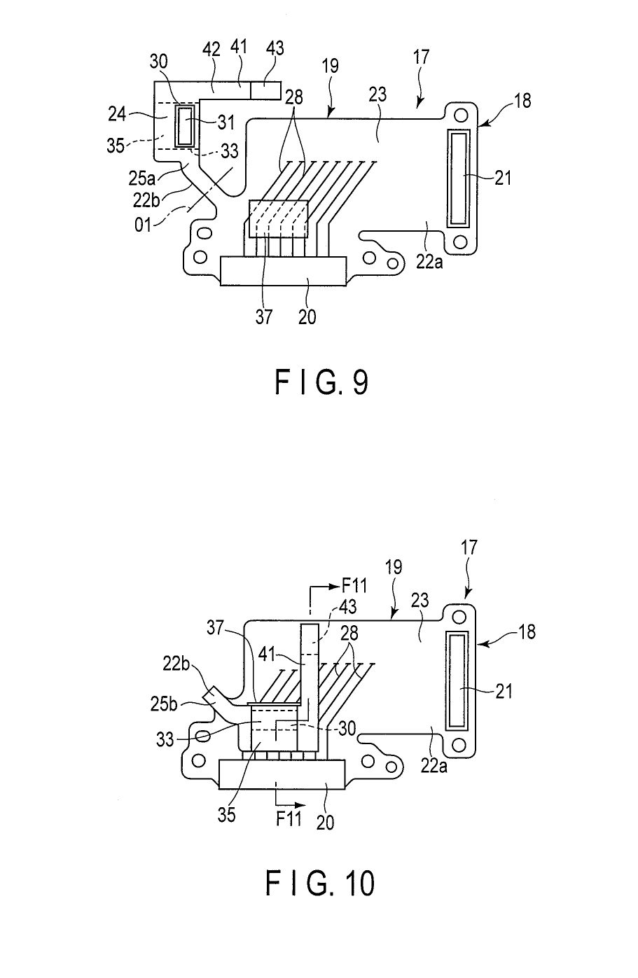

FIGS. 9 to 11 illustrate a second embodiment.

The second embodiment differs from the first embodiment in the shape of the extension portion 22b of the flexible substrate 19. The rest of the structures of the circuit module 17 and the display 3 are the same as those of the first embodiment. Therefore, the portions of the structures same as those of the first embodiment are denoted by the same reference numbers and will not be newly described.

As shown in FIG. 9, the extension portion 22b comprises a connecting portion 41 extended from the switch supporting portion 24 as a single unit. The connecting portion 41 extends in the form of a band to the opposite side of the projecting portion 35 of the first reinforcing plate 33. The connecting portion 41 comprises a third surface 42 contiguous to the first surface 25a of the extension portion 22b. To a fore-end portion of the third surface 42, an adhesive 43 is applied.

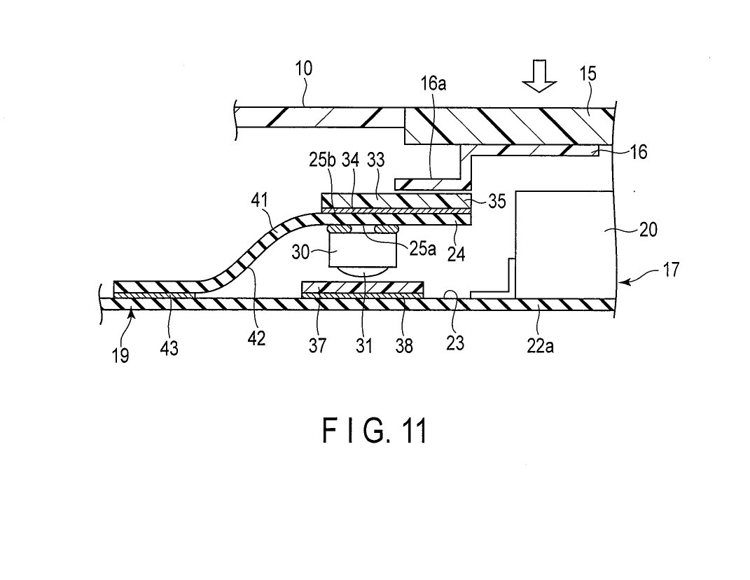

FIGS. 10 and 11 illustrate a state where the extension portion 22b is folded back once along a folding line 01 as a guide. In this state, the operating portion 31 of the switch 30 faces the second reinforcing plate 37 in a position next to the first connector 20, and the projecting portion 35 of the first reinforcing plate 33 faces the operation end portion 16a of the switch operating element 16.

In addition, the band-shaped connecting portion 41 extends to the opposite side of the projecting portion 35 of the first reinforcing plate 33. The connecting portion 41 is smoothly curved toward the mounting surface 23 of the flexible substrate 19 and its fore-end portion is bonded to the mounting surface 23 via the adhesive 43.

Consequently, the switch supporting portion 24 to which the switch 30 is soldered is held above the mounting surface 23 via the connecting portion 41 on the opposite side of the projecting portion 35.

As shown by an arrow in FIG. 11, when the pushbutton 15 of the display 3 is pushed with the operator's fingertip, the operation end portion 16a of the switch operation element 16 strikes the projecting portion 35 of the first reinforcing plate 33. Consequently, the extension portion 22b of the flexible substrate 19 is displaced so as to come close to the mounting surface 23 by taking the folded portion as a fulcrum, and the switch 30 is pressed toward the mounting surface 23.

Note that the projecting portion 35 of the first reinforcing plate 33 which receives the pressure from the pushbutton 15 is deviated from the switch 30. Consequently, when the projecting portion 35 is pushed by the operation end portion 16a, the first reinforcing plate 33 may be inclined together with the switch supporting portion 24 as the projecting portion 35 sinks.

Here, in the second embodiment, the switch supporting portion 24 to which the switch 30 is soldered is held above the mounting surface 23 via the connecting portion 41 which extends to the opposite side of the projecting portion 35. Therefore, when the projecting portion 35 is pushed by the operation end portion 16a, the pulling force acts on the connecting portion 41 and the connecting portion 41 prevents the switch supporting portion 24 from floating up.

In other words, even if the first reinforcing plate 33 is forced to lean together with the switch supporting portion 24, the switch supporting portion 24 is supported by the connecting portion 41 on the opposite side of the projecting portion 35 and sinks while remaining substantially parallel to the mounting surface 23 by not leaning together with the first reinforcing plate 33.

As a result, inclination of the switch 30 is inhibited and the operation part 31 of the switch 30 is pressed against the second reinforcing plate 37 with high accuracy. Therefore, the high responsiveness and operability of the switch 30 are maintained.

### Third Embodiment

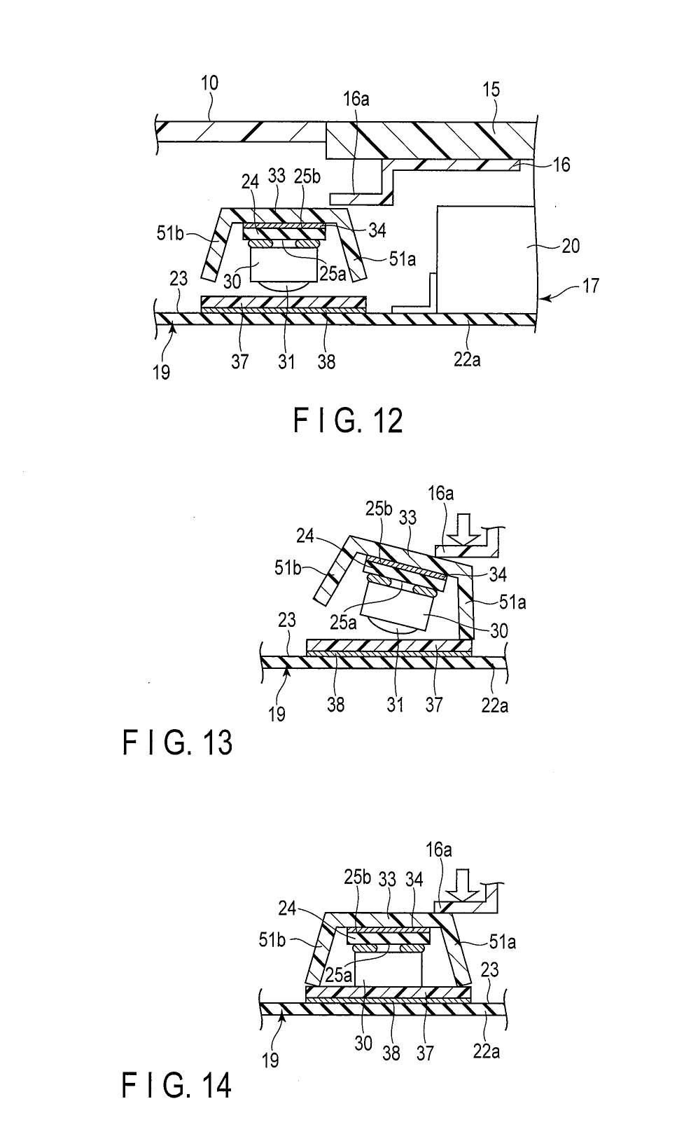

FIGS. 12 to 14 illustrate a third embodiment.

The third embodiment differs from the second embodiment in a structure which inhibits the inclination of the switch 30 when the pushbutton 15 is pushed. The rest of the structures of the circuit module 17 and the display 3 are the same as those of the first embodiment. Therefore, in the third embodiment, the portions of the structures same as those of the first embodiment are denoted with the same reference numbers and will not be newly described.

As shown in FIG. 12, in the third embodiment, an element corresponding to the projecting portion 35 of the first embodiment is omitted from the first reinforcing plate 33 and the outer edge portion of the first reinforcing plate 33 is slightly overhanging from the periphery of the switch supporting portion 24. The outer edge portion of the first reinforcing plate 33 overhangs to the same extent with respect to the switch supporting portion 24. Here, the operation end portion 16a of the switch operation element 16 presses a part of the outer edge portion, deviating from the center of the first reinforcing plate 33.

The first reinforcing plate 33 comprises a pair of walls 51a and 51b. Walls 51a and 51b extend toward the second reinforcing plate 37 from the outer edge portion of the first reinforcing plate 33 in such a manner as to sandwich the switch 30 therebetween. More specifically, one wall 51a extends from a portion of the outer edge portion of the first reinforcing plate 33 which is to be in contact with the operation end portion 16a of the switch operation element 16, toward the second reinforcing plate 37. The other wall 51b extends from the outer edge portion of the first reinforcing plate 33 toward the second reinforcing plate 37 in such a manner as to be located opposite to one wall 51a behind the switch 30. The tips of walls 51a and 51b are located on a plane substantially the same as that of the operation part 31 of the switch 30.

When the pushbutton 15 of the display 3 is pushed, the operation end portion 16a of the switch operation element 16 strikes the outer edge portion of the first reinforcing plate 33. Therefore, the extension portion 22b of the flexible substrate 19 is displaced so as to come close to the mounting surface 23 by taking a folded portion as a fulcrum, and the switch 30 is pressed toward the mounting surface 23.

Note that, since the outer edge portion of the first reinforcing plate 33 struck by the operation end portion 16a of the switch operation element 16 is deviated from the switch 30, as shown by an arrow in FIG. 13, the first reinforcing plate 33 may lean together with the switch supporting portion 24 when the outer edge portion of the first reinforcing plate 33 is pushed by the operation end portion 16a.

Here, in the third embodiment, the first reinforcing plate 33 comprises one wall 51a extending toward the second reinforcing plate 37 from the portion which is to be in contact with the operation end portion 16a of the switch operation element 16. With this structure, when the first reinforcing plate 33 leans, the tip of wall 51a strikes the second reinforcing plate 37. Then, based on the principle of leverage, the first reinforcing plate 33 pivots on the contact portion of the tip of wall 51a with the second reinforcing plate 37 such that the first reinforcing plate 33 becomes in parallel with the second reinforcing plate 37. By this pivoting, the tip of the other wall 51b strikes the second reinforcing plate 37 and the pair of walls 51a and 51b is interposed between the first reinforcing plate 33 and the second reinforcing plate 37.

As a result, the switch supporting portion 24 and the first reinforcing plate 33 become in parallel with the second reinforcing plate 37, and the inclination of the switch 30 is inhibited. Therefore, the operating portion 31 of the switch 30 is pressed against the second reinforcing plate 37 with high accuracy, which enhances the responsiveness and operability of the switch 30.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. An electronic apparatus comprising:
a housing provided with a pushing portion; and
a circuit module provided inside the housing,
wherein the circuit module comprises:
a flexible substrate comprising a base portion comprising a mounting surface, and an extension portion extending from a periphery of the base portion, the mounting surface being provided with a plurality of conductor patterns thereon;
a switch provided in a fore-end portion of the extension portion of the flexible substrate and comprising an operating portion operated by the pushing portion;
a first pressure receiving portion provided in the fore-end portion of the extension portion of the flexible substrate and located behind the switch; and
a second, pressure receiving portion provided on the mounting surface of the flexible substrate,
wherein, by folding back the extension portion toward the mounting surface once, the switch is interposed between the first and second pressure receiving portions, the operating portion of the switch faces the second pressure receiving portion, and the first pressure receiving portion faces to the direction of the pushing portion.

2. The electronic apparatus of claim 1, wherein the first pressure receiving portion is a plate harder than the extension portion of the flexible substrate.

3. The electronic apparatus of claim 1, wherein the second pressure receiving portion is a plate harder than the base portion of the flexible substrate.

4. The electronic apparatus of claim 3, wherein the second pressure receiving portion is bonded onto the mounting surface of the base portion such that the second pressure receiving portion covers the conductor patterns.

5. The electronic apparatus of claim 1, wherein the switch is provided inside the housing at a position deviated from the pushing portion, and the first pressure receiving portion comprises a projecting portion overhanging toward the pushing portion.

6. The electronic apparatus of claim 5, wherein the flexible substrate comprises a connecting portion extending toward the opposite side of the projecting portion of the first pressure receiving portion from the fore-end portion of the extension portion, and a fore-end portion of the connecting portion is secured to the mounting surface of the base portion.

7. The electronic apparatus of claim 1, wherein the first pressure receiving portion comprises a pair of walls provided such that the walls sandwich the switch therebetween, and the walls extend from the first pressure receiving portion toward the second pressure receiving portion, and the operating portion of the switch comes into contact with the second pressure receiving portion when the tips of the walls strike the second pressure receiving portion.

8. An electronic apparatus comprising:
a housing provided with a pushbutton; and
a circuit module provided inside the housing,
wherein the circuit module comprises:
a flexible substrate comprising a base portion comprising a mounting surface, and an extension portion extending from a periphery of the base portion as a single unit, the mounting surface being provided with a plurality of conductor patterns thereon, and the extension portion being folded back toward the mounting surface once;
a connector mounted on the mounting surface of the flexible substrate and electrically connected with conductor patterns;
a switch provided in a fore-end portion of the extension portion of the flexible substrate and comprising an operating portion which faces the mounting surface;
a first pressure receiving portion provided in the fore-end portion of the extension portion of the flexible substrate, located behind the switch, and pushed by the pushbutton; and
a second pressure receiving portion interposed between the mounting surface of the flexible substrate and the operating portion of the switch,
wherein the operating portion of the switch is pressed against the second pressure receiving portion via the first pressure receiving portion when the pushbutton is pushed.

9. The electronic apparatus of claim 8, wherein the first and second pressure receiving portions are plates harder than the flexible substrate, and the second pressure receiving portion is secured onto the mounting surface such that the second pressure receiving portion covers the conductor patterns.

10. The electronic apparatus of claim 8, wherein the switch is provided inside the housing at a position deviated from the pushbutton, and the first pressure receiving portion comprises a projecting portion overhanging toward the pushbutton.

11. The electronic apparatus of claim 8, further comprising a main body which comprises a supporting portion which supports the housing and connects to the connector detachably.

12. A circuit module comprising:
a flexible substrate comprising a base portion comprising a mounting surface, and an extension portion which extends from a periphery of the base portion as a single unit, the mounting surface being provided with a plurality of conductor patterns thereon, and the extension portion being folded back toward the mounting surface once,
a circuit component mounted on the mounting surface of the flexible substrate and connected to the conductor patterns electrically;
a switch provided in a fore-end portion of the extension portion of the flexible substrate and comprising an operating portion which faces the mounting surface;
a first pressure receiving portion provided in the fore-end portion of the extension portion of the flexible substrate and located behind the switch; and
a second pressure receiving portion interposed between the mounting surface of the flexible substrate and the operating portion of the switch,
wherein the operating portion of the switch is pressed against the second pressure receiving portion when the first pressure receiving portion receives pushing pressure from outside.

13. The circuit module of claim 12, wherein the first and second pressure receiving portions are plates harder than the flexible substrate, and the second pressure receiving portion is secured onto the mounting surface of the substrate.

14. The circuit module of claim 12, wherein the first pressure receiving portion comprises a projecting portion overhanging around the switch.

15. The circuit module of claim 14, wherein the flexible substrate comprises a connecting portion extending toward the opposite side of the projecting portion of the first pressure receiving portion from the fore-end portion of the extension portion, and a fore-end portion of the connecting portion is secured to the mounting surface.

16. The circuit module of claim 12, wherein the first pressure receiving portion comprises a pair of walls provided such that the walls sandwich the switch therebetween, the walls extend from the first pressure receiving portion toward the second pressure receiving portion, and the operating portion of the switch comes to contact with the second pressure receiving portion when the tips of the walls strike the second pressure receiving portion.
